(19) United States
(12) Patent Application Publication
(10) Pub. No.: US 2009/0010218 A1
(43) Pub. Date: Jan. 8, 2009

(54) METHOD AND APPARATUS FOR RESERVING CHANNEL CAPACITY

(76) Inventors: Janne Petteri TERVONEN, Espoo (FI); Juha Salokannel, Tampere (FI)

Correspondence Address: DITTHAVONG MORI & STEINER, P.C., 918 Prince St., Alexandria, VA, 22314, US

(21) Appl. No.: 12/163,230

(22) Filed: Sep. 22, 2008

Related U.S. Application Data
(60) Provisional application No. 60/947,210, filed on Jun. 29, 2007.

(51) Int. Cl. H04Q 7/00

(52) U.S. Cl. 370/329

(57) ABSTRACT

An approach is provided for reserving channel capacity. A device indicates non-use of a reservation of a resource of a frame corresponding to a channel access mechanism using a beacon transmission within a beacon period of the frame. Additionally, the device indicates that the reservation, in a data period of the frame, is temporarily freed.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), WiMedia™, etc.), provide users with the convenience of mobility along with a rich set of services and features. For example, personal area networks (PAN) have emerged, which employ Ultra Wideband (UWB) technology or Bluetooth™ to provide wireless connectivity over a “short” distance or range. PAN for UWB is specified in Institute of Electrical & Electronics Engineers (IEEE) 802.15.3a and WiMedia™.

To promote greater adoption, the telecommunication industry, from manufacturers to service providers, has agreed at great expense and effort to develop standards for communication protocols that underlie the various services and features. One area of effort involves resource allocation. Traditionally, spectral efficiency has been compromised for reduced complexity in allocating resources.

### SUMMARY OF EXAMPLE EMBODIMENTS

Therefore, there is a need for an approach for providing efficient resource allocation.

According to one embodiment of the invention, a method comprises indicating non-use of a reservation of a resource of a frame corresponding to a channel access mechanism using a beacon transmission within a beacon period of the frame. The method also comprises indicating that the reservation, in a data period of the frame, is temporarily freed.

According to another embodiment of the invention, an apparatus comprises a reservation module configured to indicate non-use of a reservation of a resource of a frame corresponding to a channel access mechanism using a beacon transmission within a beacon period of the frame, and to indicate that the reservation, during a data period of the frame, is temporarily freed.

According to another embodiment of the invention, a method comprises receiving a beacon message indicating non-use of a reservation of a resource of a frame corresponding to a channel access mechanism. The method also comprises disregarding the reservation in response to the received beacon message.

According to yet another embodiment of the invention, an apparatus comprises a reservation module configured to receive a beacon message indicating non-use of a reservation of a resource of a frame corresponding to a channel access mechanism, and to disregard the reservation in response to the received beacon message.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of a communication system capable of selectively reserving channel capacity, according to various embodiments;

FIGS. 2A and 2B are diagrams of a medium access control (MAC) superframe structure, according to an example embodiment relating to the WiMedia™ environment;

FIG. 3 is a diagram of an example superframe providing reservation of a real-time application, according to an example embodiment;

FIGS. 4A-4F are flowcharts of processes for temporarily releasing reservations associated with a channel access mechanism, according to various example embodiments;

FIG. 5 is a diagram of information element (IE) for indicating use of a reservation, according to various example embodiments of the invention;

FIG. 6 is a diagram of information elements (IE) for indicating duration of a temporary release of a reservation, according to various example embodiments of the invention;

FIG. 7 is a diagram of information elements (IE) for indicating usage of reservation blocks in an allocation zone, according to various example embodiments of the invention;

FIG. 8 is a diagram of an application specific information elements (IE) for indicating usage of a reservation, according to various example embodiments of the invention; and

FIG. 9 is a diagram of hardware that can be used to implement an embodiment of the invention.

### DESCRIPTION OF EXAMPLE EMBODIMENTS

An apparatus, method, and software for temporarily releasing reservation of capacity are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to ultra-wideband (UWB) technology and a WiMedia™ communication network, it is recognized by one of ordinary skill in the art that the embodiments of the inventions have applicability to other radio technologies and systems (e.g., WiMAX of FIGS. 10A and 10B) and equivalent functional capabilities.

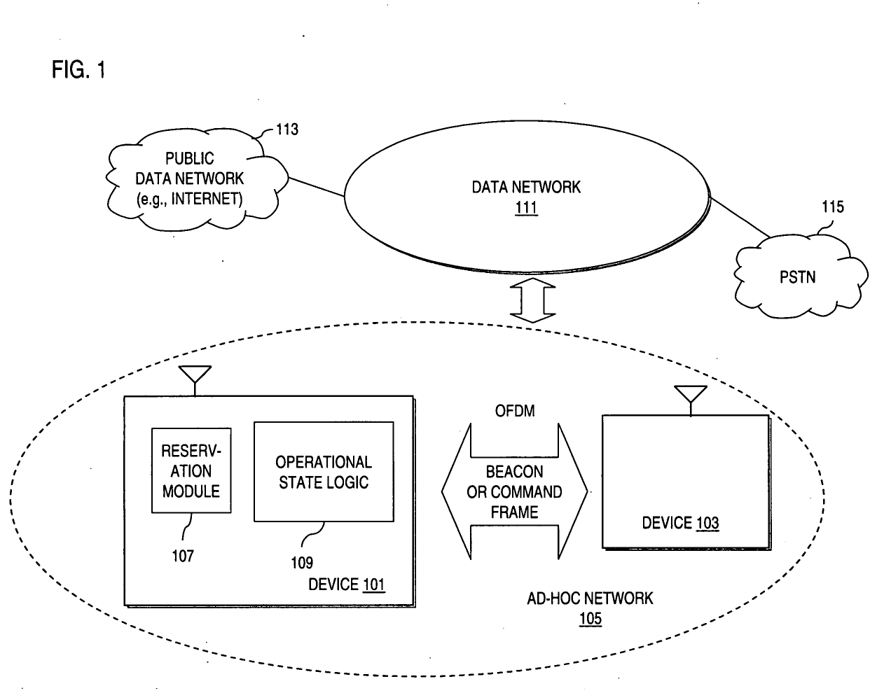

FIG. 1 is a diagram of a communication system capable of selectively reserving channel capacity, according to various embodiments. For the purposes of illustration, the communication system of FIG. 1 is described with respect to WiMedia™ UWB (ultra-wideband) technology. One or more devices 101, 103 communicate with each other to form an ad-hoc network 105. This spontaneous network is created on a temporary basis; in the case of mobile devices, these devices are considered part of the network only when they are within range of other devices. The devices 101, 103 may be any type of mobile stations, such as handsets, user equipment, terminals, stations, units, devices, multimedia tablets, Internet nodes, communicators, Personal Digital Assistants or any type of interface to the user (such as “wearable” circuitry, etc.). In addition, according to some embodiments, the devices 101, 103 may also be stationary.

In one embodiment, both devices 101, 103 employs a transceiver (not shown) to communicate using UWB technology (or any other short range radio frequency technique, such as, e.g., BLUETOOTH™).

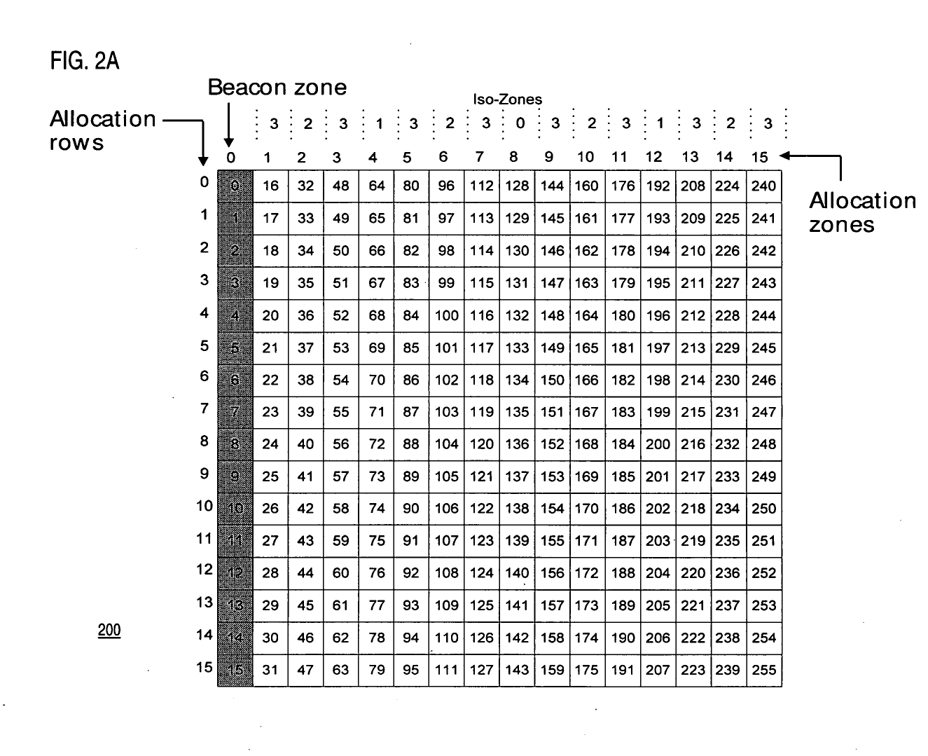

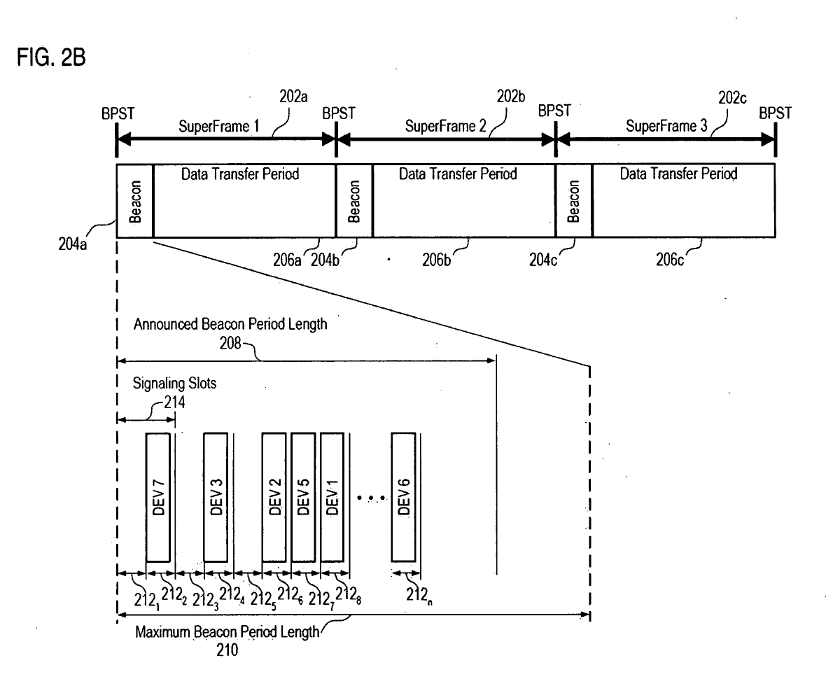

The device 101 employs a reservation module 107 to reserve capacity within a frame, such as a superframe. The reservation module 107 selectively makes reservations within the frame (e.g., WiMedia™ superframe), such that not every frame is reserved (e.g., on even part of every frame). Further, an operational state logic 109 permits the device 101 to enter an inactive state during the reservation period. Accordingly, the device 101 employs operational state logic 109 to switch from an awake (or active) state to a sleep (or inactive, idle) state. In the sleep mode, the device 101 is effectively absent with respect to the air interface; consequently, no air interface resources are utilized. It is contemplated that device 103 is similarly configured with a reservation module and operational state logic 109. Accordingly, more efficient channel usage and less power consumption can be achieved. This process is more fully described below with respect to FIGS. 2-8.

The ad-hoc network 105 may also communicate with a data network 111 (e.g., packet switched network), which has connectivity to a public data network 113 (e.g., the global Internet) and a circuit-switched telephony network 115, such as the Public Switched Telephone Network (PSTN).

By way of example, the devices 101, 103 use a medium access control layer (MAC) to allocate uplink and downlink bandwidth. As shown, Orthogonal Frequency Division Multiplexing (OFDM) is utilized to communicate from terminal to another terminal. UWB operates at a frequency, for example, between 3.1 GHz and 10.7 GHz. The system uses Orthogonal Frequency Division Multiplexing (OFDM), which utilizes a series of tones or sine waves at regularly spaced frequencies. The WiMedia™ system uses 128 tones each 4.125 MHz apart. The system, according to one embodiment, utilizes Multiband OFDM (MB-OFDM); the system hops among multiple (e.g., three) bands, spreading the signal over 1576 MHz of spectrum.

Details of the MAC layer signaling are provided in ECMA-386, entitled “High Rate Ultra Wideband PHY and MAC Standard,” ECMA Standard, 1^{st} Edition, December 2005, which is incorporated herein by reference in its entirety.

FIGS. 2A and 2B are diagrams of a medium access control (MAC) superframe structure, according to an example embodiment relating to the WiMedia™ environment. In an example embodiment, two channel access mechanisms are defined: Prioritized Contention Access (PCA) and Distributed Reservation Protocol (DRP). DRP reservations are uni-directional between one transmitter (e.g., device 101) and one or more receivers (e.g., device 103); only the owner (e.g., the transmitter) can access the channel during the DRP reservation. The intended recipient(s) is active (radio “on” or “awake”) during the DRP reservation. For example, DRP reservations include one or more MAS (Medium Access Slots); 1 MAS lasts 256 μs. In this scenario, a superframe 200 includes a total of 256 MASs.

A set of rules have been defined (e.g., detailed in ECMA-386) to control the DRP reservations made. This set of rules is denoted in MAS allocation policies; the MAS allocation policies control the size, formation and location of the DRP reservation on the superframe 200.

As shown in this UWB superframe 200, the first MAS of the superframe is on the top left corner (MAS number 0) and the last (MAS number 255) on the bottom right corner. This superframe representation is used when describing MAS allocation policies.

A reservation block is “one or more temporally contiguous MASs within a reservation.” For example, if in a reservation there are MASs 64-70 and 192-196, the first column of MASs 64-70 is a different reservation block than MASs 192-196.

Traditional approaches related to the WiMedia™ MAC specification are problematic in that both the transmitter and the receiver are required to be active (i.e., not sleeping and saving battery) during the lifetime of a DRP reservation on every single superframe, even if there is no data to be sent.

It is observed that the “owner” of the DRP reservation can release the remaining, unused MASs from the current reservation block by sending the control frame Unused DRP Reservation Announcement (UDA). A drawback with using UDA to release unused MASs is that the control frame is sent during the reservation; thus, both transmitter and the receiver must be active at least during the first MAS of the reservation (and probably before or after of the first MAS too, depending how far from beacon zone the reservation is).

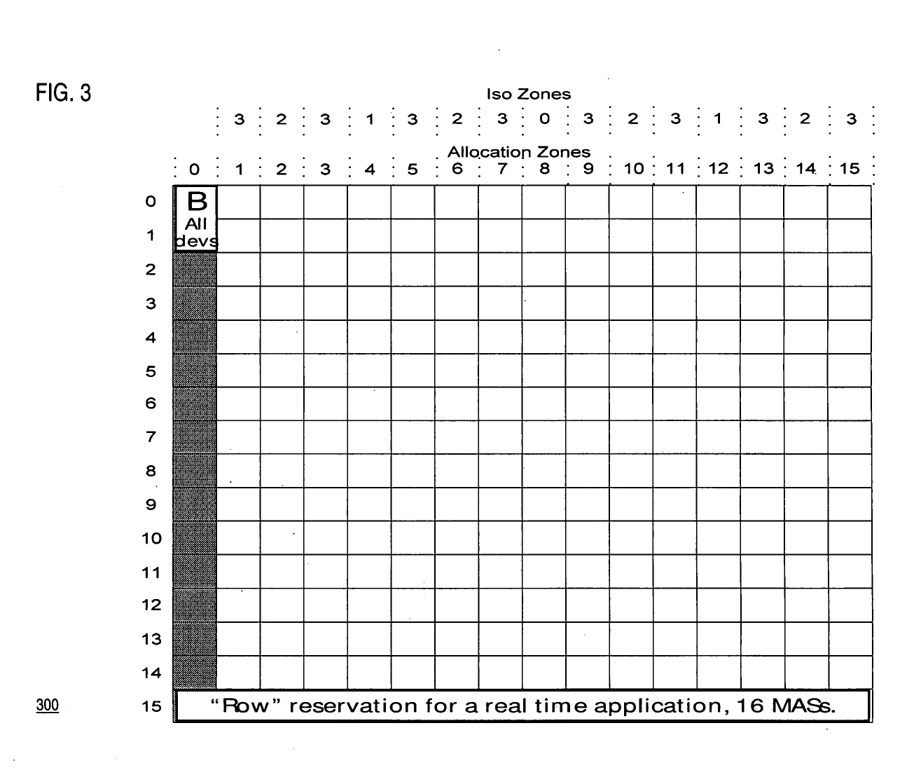

The benefit of using UDA may be basically lost if the DRP reservation includes multiple reservation blocks; FIG. 3 illustrates this point.

FIG. 2B shows a frame format having superframes 202a, 202b, and 202c. As seen, superframe 202b immediately follows superframe 202a, and superframe 202c immediately follows superframe 202b. Each superframe 202 includes a beacon period 204 and a data transfer period 206. Beacon periods 204 convey transmissions from each of the active devices in the beaconing group. By way of example, beacon period 204a has an announced length 208, which is less than or equal to a maximum beacon period length 210 (also referred to as mMaxBPLength 210).

Multiple beacon slots 212 exist during a beacon period. During these slots, devices (labeled as “DEV1 . . . DEV7”) may transmit their respective beacons. Accordingly, each of these slots may correspond to a particular device in the beaconing group. For instance, device 7 transmits in slot 212₂, device 3 in slot 212₄, device 2 in slot 212₆, device 5 in slot 212₇, device 8 in slot 212₈, and a device 6 in slot 212ₙ. The first two beacon slots (i.e., slots 212₁ and 212₂) are referred to as signaling slots. These slots are used , for example, to indicate changes in beacon period length. Accordingly, in certain situations, devices occupying the highest beacon slots may repeat their beacon transmissions in these slots. This repetition of beacon transmissions is performed in the same beacon period or in the same superframe.

Beacons may contain various overhead or networking information. For instance, beacons may include information regarding resource allocations and beaconing group configuration. Such information may be in the form of various information elements (IEs).

FIG. 3 is a diagram of an example superframe providing reservation of a real-time application, according to an example embodiment. As shown, a real-time application, for example, has requested a DRP reservation that has radio access after every 4 ms. The DRP reservation includes 16 MASs of superframe 300. However, since each MAS of the reservation is separated in time with 15 MASs, each MAS forms its own reservation block. If the transmitter notices that it does not have any data to be sent during this superframe, it can release the reserved MASs by using the UDA control frame. The problem is that the transmitter needs to release each of the reservation blocks separately. Thus, both the transmitter and the receiver is active (and not sleeping), basically during the whole superframe to release 16 MASs and to notice no data was sent.

It is also possible to release the whole DRP reservation by the reservation owner by removing the DRP IE from its beacon, if there is a longer break in the transmission. However, release of a DRP reservation takes typically one superframe and setting it up again at least three superframes within WiMedia™ environment, so this mechanism is not applicable—e.g. for an application that would have data to be sent every other superframes. Also, if a reservation is released, no guarantees can be given that a similar DRP reservation can be re-established when needed again; other devices might occupy the resources during the break.

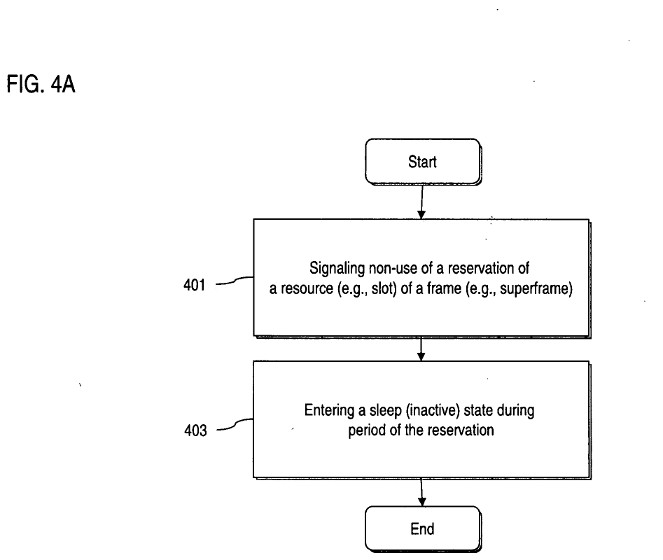

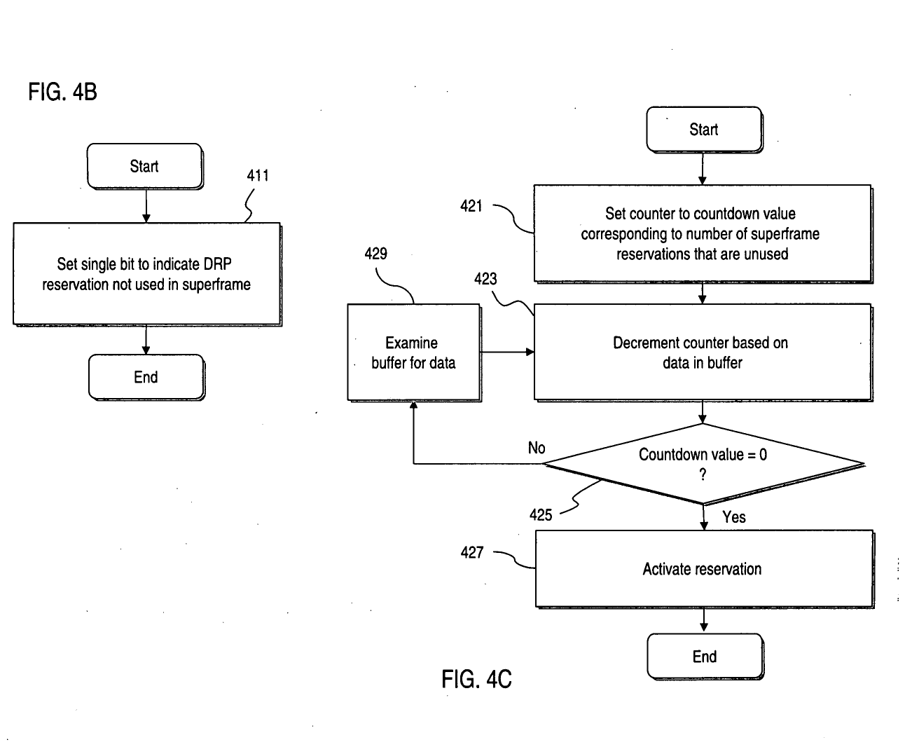

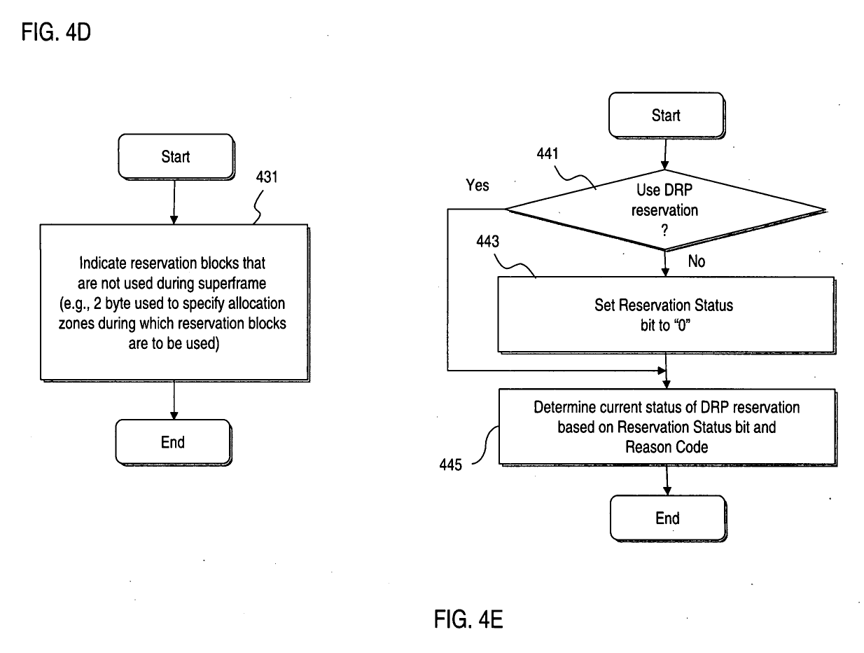

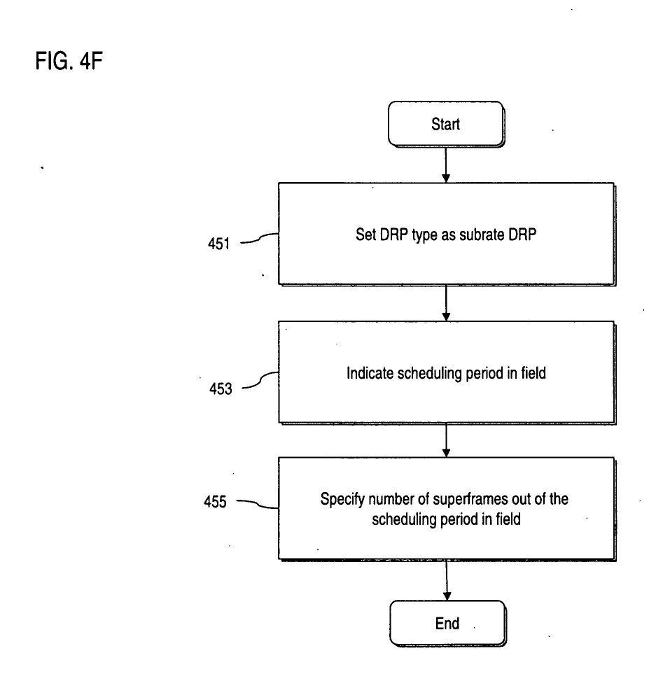

FIGS. 4A-4F are flowcharts of processes for temporarily releasing reservations associated with a channel access mechanism, according to various example embodiments. As used herein, the term “temporarily release” is used to mean not using the reserved slots (e.g., MASs) during the particular or upcoming, limited number of frames (e.g., superframes). In certain embodiments, the indication of “temporarily released reservations” is provided to other devices in the beacon transmissions that occur during the beacon period, as described with respect to FIG. 2B. As seen in FIG. 4A, a terminal signals non-use of a reservation of a resource (e.g., channel slot) of a frame, per step 401. Next, during this period, the device (or terminal) 101 can enter a “sleep” or inactive state, as in step 403.

For the purposes of illustration, this release mechanism is explained with respect to the DRP reservation. In order to “temporarily release” a DRP reservation—i.e. not using the reservation—for one or more coming superframes, several options for conveying the information exist. Thus, both the transmitter and the receiver(s) can include the DRP information elements (IEs) of the reservation in their beacons, as specified in WiMedia™ MAC specification.

In the embodiment shown in FIG. 4B, the transmitter (e.g., device 101) sets, as in step 411, a single bit within a superframe to indicate the DRP reservation is not used during this superframe.

Alternatively, as depicted in FIG. 4C, the transmitter 101 utilizes, in an example embodiment, a counter, in which a countdown value that indicates the number of superframes the reservation is unused. In step 421, the counter value is set to a value corresponding to the number of superframe reservations that are unused. The counter is decremented, per step 423, based on the data in a transmission buffer (not shown). The process, in step 425, checks the countdown value.

When the countdown value reaches zero, the reservation will be in active use (step 427). The transmitter 101 can change the countdown value to zero when data appears in its buffers even if the countdown value for the previous superframe was larger than 1, for example. If the countdown value is not zero, the process examines the buffer, as in step 429, and repeats step 423.

In another embodiment (FIG. 4D), a two-byte bit-field can be set, as in step 431, to indicate the allocation zones during which the reservation blocks are used (bit value=‘1’) and when not (bit value=‘0’).

It is noted that approaches of FIGS. 4C and 4D can be combined as another embodiment.

In FIG. 4E, a Reason Code is used with the reservation status bit to indicate current status of the reservation. The transmitter 101 uses the existing DRP IE fields to indicate that the DRP reservation is not used during the current superframe. Basically (per steps 441 and 443), this would require changing/modifying the usage of Reservation Status bit in DRP IE: when the Reservation Status bit is set to zero, the DRP reservation is not used. In ECMA-386, it is specified that the Reservation Status bit is set to zero only during the setup/negotiation of the DRP reservation. Together with the Reservation Status bit, the Reason Code field defines the current status of the DRP reservation. As such, status is determined, per step 445, based on the Reservation Status bit and the Reason Code field. Since this option would change the usage of Reservation Status bit, the Reason Code value is introduced to the specification, e.g. “Temporarily not used” (Value=5).

In yet another embodiment (shown in FIG. 4F), a DRP Type “Subrate” is defined for separating this type from other reservation types. This may be handled similar to type “Soft”, meaning that other devices may use Prioritized Contention Access (PCA) during these slots, but the owner is still prioritized to use it. However, this may be expected to work different way (Reservation Status bit changing possibly every superframe).

In an example embodiment, the schedule for using DRP Type “Subrate” may be defined in separate IE or fields. This differs from other reservation types because of the different usage of the status bit; traditionally, the status bit can be used at any time to indicate whether the DRP reservation is in use in the starting superframe. In step 451, the DRP type can be set as subrate DRP. The scheduling period can be specified within this field, as in step 453. For example, if using one byte for the schedule information, the first four bits could tell what the scheduling period is: e.g., value 7=scheduling period 8 superframes. Correspondingly, the second set of four bits of the byte is thus use to indicate how many superframes out of the scheduling period is used (step 455)—e.g., if the four-bit field has the value of 2 and scheduling field value of 7 (scheduling period=8), then the transmitter would send data during 2 superframes out of eight (evenly spread, after every fourth superframe).

In the alternative, a bit-field can be utilized to define the exact superframes when the data will be sent. To support this kind of scheduled transmission per superframes, the transmitter and the receiver needs to agree on the numbering of the superframe (or to be exact, what is the first superframe from which the scheduling period starts). For instance, if the devices are WiNet-capable, global cycle start countdown (GCSC) information could be used for this. Otherwise, Reservation Status is used to synchronize the superframe counting for the transmitter and the receiver, for example. It is noted that the bit-field may be associated with a DRP reservation block or all of the reservation blocks of a DRP IE.

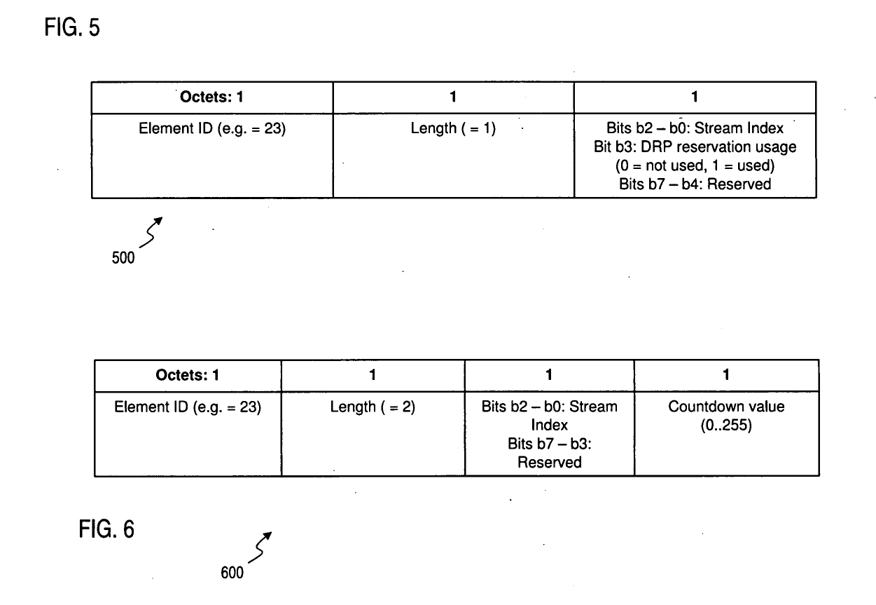

The information listed in embodiments of FIGS. 4B-4D can be added to several IEs, command frames, or control frames in the WiMedia™ MAC specification, as shown in FIGS. 5-8.

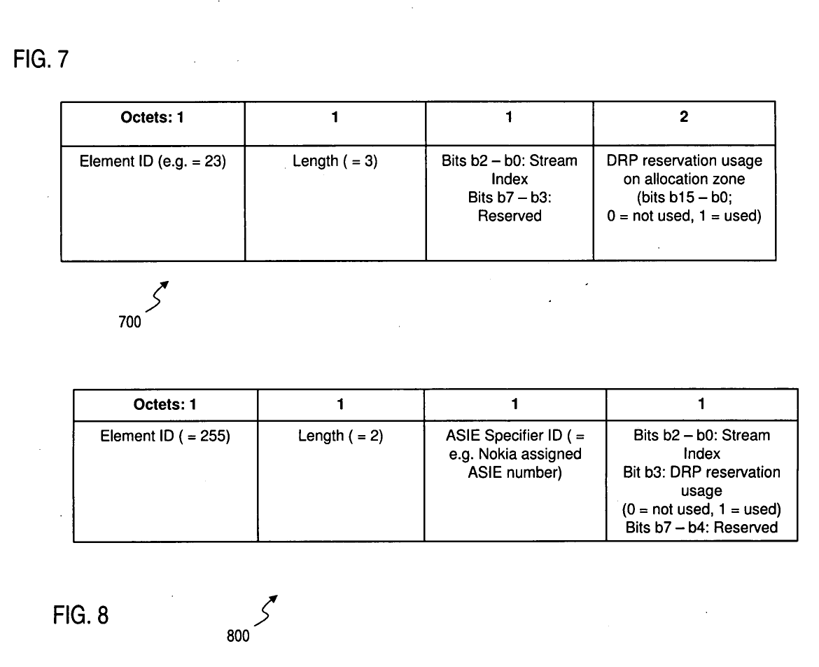

FIGS. 5-8 are diagrams of information elements (IE) of a channel access protocol for temporarily releasing reservations, according to various example embodiments of the invention. For ease of reference, various embodiments, denoted “Options A-E” are explained. In one option (Option A), an IE 500 in the beacon is defined, as seen in FIG. 5. In this embodiment, a single bit is used to indicate the usage of the DRP reservation. Alternatively, the IE formats 600 and 700 of FIGS. 6 and 7, respectively, can be utilized. With respect to FIG. 6, the countdown field is used to indicate the duration of “temporary release” of a DRP. As for FIG. 7, the bit field specifies the usage of reservation blocks in an allocation zone.

In another embodiment (Option B), a control frame type is defined for releasing all the reservation blocks for this superframe. The contents of this Unused Superframe for DRP Reservation Announcement (USDA) can resemble those of the UDA—i.e. the list of DevAddresses to whom the control frame is intended. However, the Frame Subtype field value is different, e.g. 6 (the first unused value). According to the current UDA definition, a response message is also needed. When a device receives USDA control frame with its DevAddr, the device sends Unused Superframe for DRP Reservation Response (USDR) back to the transmitter. The frame does not have payload, and can be defined otherwise as UDR (as specified in ECMA-386).

Under the above approach, since the control frames are sent during data transfer period (not in beacons), both the transmitter and the receiver need to be active at least during one MAS. Thus, this option can be less power-efficient than option A.

In another embodiment (Option C), an application-specific IE (ASIE) 800 is defined, as shown in FIG. 8, to be added in the beacon. A single bit is utilized to indicate the usage of the DRP reservation.

According to other embodiments, the contents of the ASIE 800 can resemble that of the IE of Option A. In one embodiment (Option D), an application-specific control frame is defined for releasing all the reservation blocks for this superframe. The content of this control frame (and response frame) is similar to what was defined for USDA (and USDR) above in option B, except Frame Subtype field gets value 14 (for Application-specific control frame) and the frame control body starts with a Specifier ID (e.g. vendor assigned number in WiMedia™ Assigned Numbers). This option can be implemented without standard modification. Since the control frames are sent during data transfer period (not in beacons), both the transmitter and the receiver need to be active at least during one MAS. Thus, this option is less power-efficient than option C.

In yet another embodiment (Option E), for the formats of FIGS. 5 and 6, the existing DRP IE Reserved field can be used, e.g., three Reserved bits in the DRP Control field. For FIG. 5, only one bit could be used from the Reserved field to indicate the DRP reservation is not used during this superframe. For FIG. 6, all the three available Reserved bits could be used: when the three-bit field value is zero, the DRP reservation is used and the receiver can be ready to receive data. When the three-bit field has non-zero value, the field shows countdown value to the next superframe when the reservation is again used.

If a DRP reservation will not be used every superframe, the MASs can be utilized by other devices, when no data is transmitted. This requires that the transmitter and the receiver agree not to use the DRP reservation with certain pattern. In practice, this would mean that the DRP reservations are made according to some scheduling periods. For example, device A and B could reserve a DRP reservation to be used every second superframe. Now devices C and D could use the “leftover” superframes from device A and B. A mechanism for numbering the superframes is needed. For this, in one embodiment the GCSC (from WiNet) is used; alternatively, a similar kind of mechanism can be utilized at the MAC level. Further, a mechanism for reserving only certain superframes with certain MASs is defined. Some possible mechanisms for inter-superframe DRP reservations between multiple devices can be defined.

It is contemplated, according to certain embodiments, that the information specified by the IEs can be specified in command frames or control frames.

Under traditional approaches, it has been assumed that DRP reservations are used constantly during every superframe. However, since the length of the superframe is only 65 ms, there are plenty of applications that could exploit reservations with less frequent channel access. When a DRP reservation is “released”—i.e. not using the reservation—for a number of superframes, both the transmitter and the receiver can considerably save in power consumption.

One of ordinary skill in the art would recognize that the processes for providing flexible reservation scheduling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such example hardware for performing the described functions is detailed below.

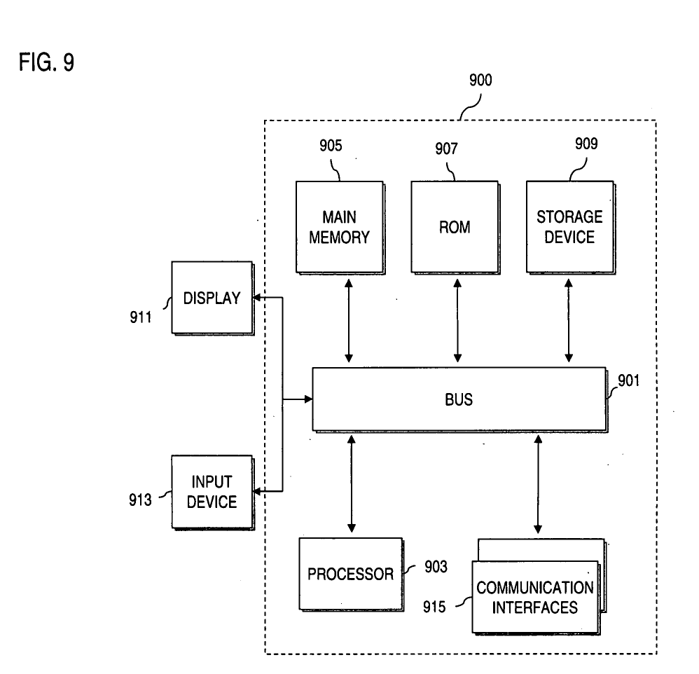

FIG. 9 illustrates example hardware upon which various embodiments of the invention can be implemented. A computing system 900 includes a bus 901 or other communication mechanism for communicating information and a processor 903 coupled to the bus 901 for processing information. The computing system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computing system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computing system 900 may be coupled via the bus 901 to a display 911, such as a liquid crystal display, or active matrix display, for displaying information to a user. An input device 913, such as a keyboard including alphanumeric and other keys, may be coupled to the bus 901 for communicating information and command selections to the processor 903. The input device 913 can include a cursor control, such as a mouse, a trackball, or cursor direction keys, for communicating direction information and command selections to the processor 903 and for controlling cursor movement on the display 911.

According to various embodiments of the invention, the processes described herein can be provided by the computing system 900 in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 900 also includes at least one communication interface 915 coupled to bus 901. The communication interface 915 provides a two-way data communication coupling to a network link (not shown). The communication interface 915 sends and receives electrical, electromagnetic, or optical signals that carry digital data streams representing various types of information. Further, the communication interface 915 can include peripheral interface devices, such as a Universal Serial Bus (USB) interface, a PCMCIA (Personal Computer Memory Card International Association) interface, etc.

The processor 903 may execute the transmitted code while being received and/or store the code in the storage device 909, or other non-volatile storage for later execution. In this manner, the computing system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
indicating non-use of a reservation of a resource of a frame corresponding to a channel access mechanism using a beacon transmission within a beacon period of the frame; and
indicating that the reservation, in a data period of the frame, is temporarily freed.

2. A method according to claim 1, further comprising:
entering an inactive state during a period of the reservation.

3. A method according to claim 1, wherein the frame is a superframe having a format according to a distributed reservation protocol.

4. A method according to claim 3, further comprising:
setting a bit to indicate the non-use of the reservation, wherein the bit is within a beacon area of the superframe.

5. A method according to claim 4, wherein the bit is a counter bit field.

6. A method according to claim 3, further comprising:
tracking number of superframes in which reservation is unused, wherein the reservation is subsequently used upon satisfying a threshold relating to the tracked number of superframes.

7. A method according to claim 3, wherein the superframe includes a field specifying which reservation blocks of the superframe are unused.

8. A method according to claim 3, wherein the superframe includes a reservation status field and a reason code field used in conjunction to specify the non-use of the reservation.

9. A method according to claim 3, wherein the superframe includes a subrate field that specifies a scheduling period and associated number of superframes used during the scheduling period.

10. A method according to claim 3, further comprising:
releasing one or more slots of the superframe to a device that did not reserve the slot.

11. A computer-readable storage medium carrying one or more sequences of one or more instructions which, when executed by one or more processors, cause the one or more processors to perform the method of claim 1.

12 An apparatus comprising:
a reservation module configured to indicate non-use of a reservation of a resource of a frame corresponding to a channel access mechanism using a beacon transmission within a beacon period of the frame, and to indicate that the reservation, during a data period of the frame, is temporarily freed.

13. An apparatus according to claim 12, further comprising:
entering an inactive state during a period of the reservation.

14. An apparatus according to claim 12, wherein the frame is a superframe having a format according to a distributed reservation protocol.

15. An apparatus according to claim 14, wherein the reservation module is further configured to set a bit to indicate the non-use of the reservation, wherein the bit is within a beacon area of the superframe.

16. An apparatus according to claim 15, wherein the bit is a counter bit field.

17. An apparatus according to claim 14, wherein the reservation module is further configured to track number of superframes in which reservation is unused, the reservation being subsequently used upon satisfying a threshold relating to the tracked number of superframes.

18. An apparatus according to claim 14, wherein the superframe includes a field specifying which reservation blocks of the superframe are unused.

19. An apparatus according to claim 14, wherein the superframe includes a reservation status field and a reason code field used in conjunction to specify the non-use of the reservation.

20. An apparatus according to claim 14, wherein the superframe includes a subrate field that specifies a scheduling period and associated number of superframes used during the scheduling period.

21. An apparatus according to claim 14, wherein the reservation module is further configured to release one or more slots of the superframe to a device that did not reserve the slot.

22. A method comprising:
receiving a beacon message indicating non-use of a reservation of a resource of a frame corresponding to a channel access mechanism; and
disregarding the reservation in response to the received beacon message.

23. A method according to claim 22, further comprising:
entering an inactive state during a period of the reservation.

24. A computer-readable storage medium carrying one or more sequences of one or more instructions which, when executed by one or more processors, cause the one or more processors to perform the method of claim 22.

25. An apparatus comprising:
a reservation module configured to receive a beacon message indicating non-use of a reservation of a resource of a frame corresponding to a channel access mechanism, and to disregard the reservation in response to the received beacon message.

26. An apparatus according to claim 25, further comprising:
entering an inactive state during a period of the reservation.
